(19) United States
(12) Patent Application Publication
(10) Pub. No.: US 2026/0326125 A1
(43) Pub. Date: Oct. 22, 2026

(54) NOZZLE, DYNAMIC SPRAYING DEVICE, COATING METHOD AND REPAIR METHOD ASSOCIATED THEREWITH

(71) Applicant: SAFRAN NACELLES, GONFREVILLE-L'ORCHER (FR)

(72) Inventors: Dylan Laurent Pascal TASSERY, MOISSY CRAMAYEL (FR); Manon GALLAIS, MOISSY CRAMAYEL (FR); Frédéric AMBLARD, MOISSY CRAMAYEL (FR); Grégory PRUDHOMME, MOISSY CRAMAYEL (FR); Daniel BERNARD, MOISSY CRAMAYEL (FR)

(21) Appl. No.: 19/116,794

(22) PCT Filed: Sep. 22, 2023
(86) PCT No.: PCT/FR2023/051466

§ 371 Date: May 6, 2025

(30) Foreign Application Priority Data
Sep. 29, 2022 (FR) FR2209900

(51) Int. Cl. B05B 7/14; B05D 1/12

(52) U.S. Cl. CPC B05B 7/1486; B05D 1/12

(57) ABSTRACT

A nozzle includes a spray gas supply pipe; a mixing chamber for mixing spray gas and powdered material into an accelerated mixture which is connected, via an upstream end, to the spray gas supply pipe; a pipe for spraying the accelerated mixture which is connected to a downstream end of the mixing chamber, wherein the spray gas supply pipe is U-shaped with a first arm oriented along a first axis and a second arm oriented along a second axis which is perpendicular to the first axis, the first arm being connected to the upstream end; the pipe for spraying the accelerated mixture extends straight along the first axis and includes a spray opening.

### TECHNICAL FIELD OF THE INVENTION

The technical field of the invention is the repair of aircraft turbomachine pieces.

The present invention relates to a nozzle, a device for cold-gas dynamically spraying powdered material, a dynamic spray coating method and a method for repairing an annular contact flange for an aircraft turbomachine associated therewith.

### TECHNOLOGICAL BACKGROUND OF THE INVENTION

Within the scope of repairing aircraft turbomachine components, there are frequently problems of accessibility to these components. These problems exist, for example, for damage caused by frictional wear of an annular contact flange between the engine and the reverser of a turbomachine (also called a J-ring), for which no industrially applicable structural repair solution is known. In the event of excessive wear, this annular contact flange is entirely replaced. Such an annular contact flange 11 is represented in FIG. 1.

Replacing an aluminium J-ring is a complex and time-consuming operation. Thus, it would be beneficial to find an alternative to replacing this piece, enabling it to be repaired on-wing, that is, when the piece is still installed on the turbomachine, and also enabling the aircraft to be quickly released.

A gas dynamic spray repair method (briefly cold spray), referred to as hardfacing, can be implemented using a direct-jet nozzle for spraying metallic powder at very high speed to fill in damage on the surface of worn pieces.

FIG. 2 schematically represents a conventional spray device 50 fitted with a nozzle 10. This device 50 comprises, among other things, a nozzle 10 and a spray torch 60 located as a longitudinal extension of the nozzle 10. The conventional device 50 is placed facing a surface to be hardfaced S, stated differently to be coated with an initially powdery material. FIG. 3 is a cross-section view of the geometry of a “J-ring” type annular contact flange 11 as well as a zone Z, to be repaired, of this annular contact flange 11. It can be observed, as illustrated in FIGS. 4 and 5, that a spray device as illustrated in FIG. 2 cannot be inserted into this architecture without interfering with other components near the annular contact flange 11. Stated differently, the geometry of the “J-ring” type annular contact flange 11 makes it impossible to use a conventional spray device 50 such as illustrated in FIG. 2.

### SUMMARY OF THE INVENTION

The invention provides a solution to the problems discussed previously, making it possible to overcome the above-mentioned problems of accessibility and overall size in order to repair on-wing a turbomachine piece of the “J-ring” type, or any other type of piece whose geometry does not allow a conventional repair device to be used.

A first aspect of the invention relates to a nozzle comprising:
a spray gas supply duct,
a chamber for mixing spray gas and powdered material into an accelerated mixture, connected, through an upstream end, to the spray gas supply duct,
a spray duct for the accelerated mixture connected to a downstream end of the mixing chamber,
the spray gas supply duct being “U” shaped with a first arm oriented along a first axis and a second arm oriented along a second axis perpendicular to the first axis, the first arm being connected to the upstream end,
the spray duct for the accelerated mixture extending rectilinearly along the first axis and comprising a spray opening.

By virtue of the invention, it is possible to position the nozzle according to the invention so that, after integration into a cold-gas spray device, the gas spray direction and the gas injection direction are different.

A second aspect of the invention relates to a device for gas dynamically spraying powdered material comprising a nozzle such as previously described and: a spray torch extending along the second axis and connected to the second arm of the spray gas supply duct, a powdered material supply duct connected to the mixing chamber.

Thus, the gas dynamic spray device according to the invention is more compact and can be inserted into reduced spaces such as the space around a “J-ring” type annular contact flange. “On-wing” repair of such components, that is, those still installed on a turbomachine, is then possible, and it is no longer necessary to replace these components entirely. This on-wing repair offers time saving relative to a complete replacement.

Advantageously, the powdered material supply duct extends along a third axis perpendicular to the first axis and to the second axis.

A third aspect of the invention relates to a method for coating a metal piece by dynamically spraying (metallic or partially metallic) powder, implemented by a dynamic spray device as described previously, comprising the following steps of:
positioning a surface to be coated facing the spray opening,
injecting high-speed gas into the spray torch,
injecting a powder into the powdered material supply duct,
spraying the mixture formed by the high-speed gas and the powder via the spray duct onto the surface to be coated.

In the present disclosure, the powder can be metallic or partially metallic.

Advantageously, the high-speed gas is a cold gas.

In the present disclosure, the term “cold gas” refers to a high-speed gas with a temperature below 750 °C.

Advantageously, the powder is mostly comprised of aluminium or aluminium alloy. This is particularly adapted for an aluminium or aluminium alloy piece.

A fourth aspect of the invention relates to a method for repairing an annular contact flange for an aircraft turbomachine implemented by a dynamic spray device as described previously, comprising the following steps of:
positioning a part of the annular contact flange to be repaired facing the spray opening,
injecting high-speed gas into the spray torch,
injecting a metallic powder into the powdered material supply duct,
spraying the mixture formed by the high-speed gas and the metallic powder via the spray duct onto said part,
the annular contact flange being installed on a turbomachine.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a “J-ring” type annular contact flange installed on an aircraft turbomachine reverser.

FIG. 2 shows a dynamic spray device according to prior art.

FIG. 3 is a profile view of an annular contact flange such as that of FIG. 1.

FIG. 4 schematically represents a virtual intersection of a dynamic spray device according to prior art with a “J-ring” type annular contact flange.

FIG. 5 schematically represents another virtual intersection of a dynamic spray device according to prior art with a “J-ring” type annular contact flange.

FIG. 6 represents a nozzle according to one exemplary embodiment of the invention.

FIG. 7 represents a perspective view of a dynamic spray device according to one exemplary embodiment of the invention, in a functional position.

FIG. 8 represents a profile view of the dynamic spray device of FIG. 7 in the functional position for repairing a “J-ring” type annular contact flange.

### DETAILED DESCRIPTION

The figures are set forth by way of indicating and in no way limiting purposes of the invention. Unless otherwise specified, a same element appearing in different figures has a single reference.

A first object of the invention relates to a nozzle 1, represented in FIG. 6.

The nozzle 1 of FIG. 6 comprises:
a spray gas supply duct 2,
a chamber 3 for mixing spray gas and powdered material into an accelerated mixture, connected, through an upstream end 31 to the spray gas supply duct 2,
a spray duct 4 for the accelerated mixture connected to a downstream end 32 of the mixing chamber 3.

The terms upstream and downstream are defined in relation to the direction of propagation of the accelerated mixture, from the mixing chamber 3 towards a surface to be hardfaced.

The spray gas supply duct 2 is “U” shaped with a first arm 21 oriented along a first axis X and a second arm 22 oriented along a second axis Y perpendicular to the first axis X. The first arm 21 is connected to the upstream end 31.

The spray duct 4 for the accelerated mixture rectilinearly extends along the first axis X and comprises a spray opening 41 through which the accelerated mixture is sprayed from the mixing chamber 3. This supply after the bends enables clogging of the nozzle 2 to be avoided.

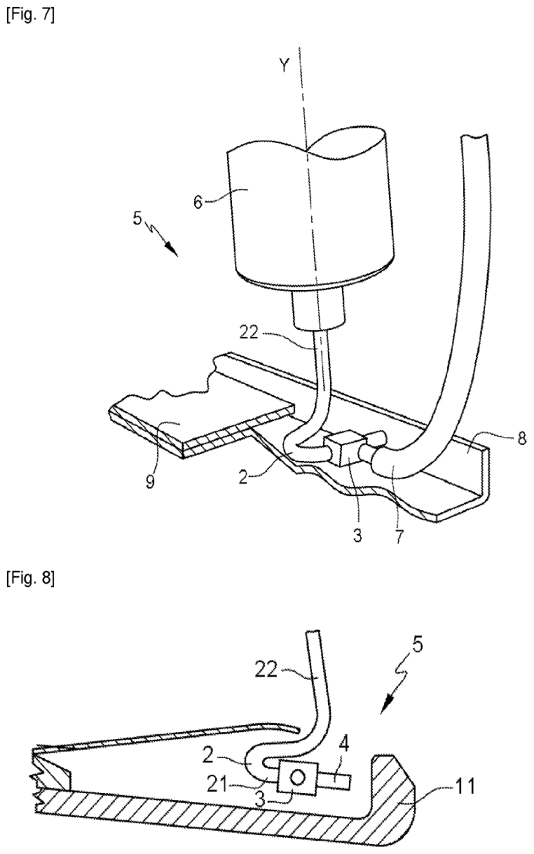

A second object of the invention relates to a device 5 for gas dynamically spraying powdered material comprising a nozzle 1 such as the nozzle 1 represented in FIG. 6. An example of this dynamic spray device 5 is represented in FIG. 7.

The dynamic spray device 5 further comprises:
a spray torch 6 extending along the second axis Y and connected to the second arm 22 of the spray gas supply duct 2,
a powdered material supply duct 7 connected to the mixing chamber 3.

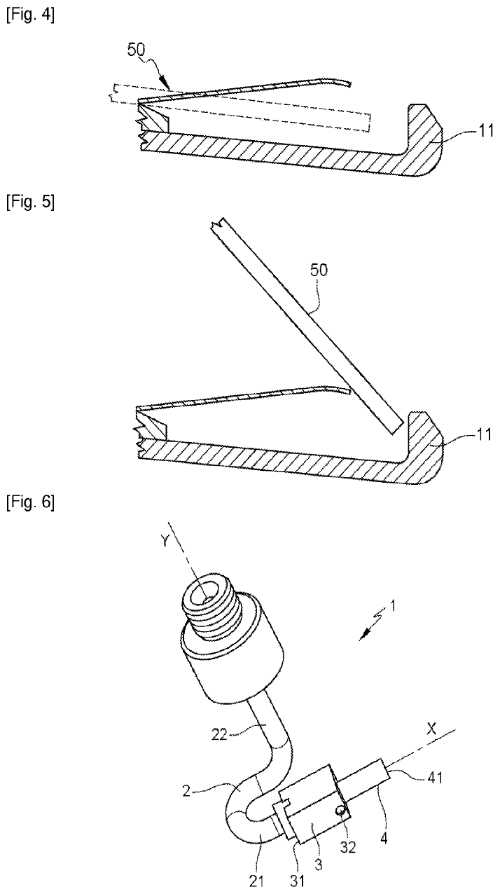

In FIG. 7, a surface to be hardfaced 8, stated differently, to be coated with metallic powder by the dynamic spray device 5 is also represented. Additionally, geometry elements 9 are also represented in FIG. 7. These geometry elements 9 do not allow the use of a conventional spray device 50 such as that represented in FIG. 2. Indeed, they would interfere with the spray torch 60, which could not be positioned as an extension of the nozzle 10, as already illustrated in FIGS. 4 and 5.

As visible in FIG. 7, positioning the spray torch 6 along the second axis Y, herein vertical, enables the dynamic spray device 5 to be inserted into the available space between the surface to be hardfaced 8 and the geometry elements 9. Thus, spraying metallic powder onto the surface to be repaired 8 is made possible.

Advantageously, the powdered material supply duct 7 is connected to the mixing chamber 3, stated differently, downstream of the spray gas supply duct 2. This position of the junction between the powdered material supply duct 7 and the nozzle 1 avoids deterioration thereof. Indeed, tests have shown that a powder supply upstream of the “U” shape of the spray gas supply duct 2 leads to perforation or clogging of the nozzle 1, and makes it unusable in this configuration.

FIG. 8 is a side view of the dynamic spray device 5 of FIG. 7 in the functional position for spraying on a “J-ring” type annular contact flange 11. In FIG. 8, it can be observed that the geometry of the dynamic spray device 5 allows it to be inserted so as to position the spray duct 4 substantially perpendicularly to the internal surface of the “J-ring” type annular contact flange 11.

A method for repairing on-wing a “J-ring” type annular contact flange 11 having worn parts, is now described.

The annular contact flange 11 is installed on an aircraft turbomachine.

The dynamic spray device 5 previously described, as illustrated in FIG. 7, is installed so that the spray duct 4 is approximately perpendicular to a surface to be hardfaced, with the spray opening facing the surface to be hardfaced.

Preferably, the spraying principle is gas dynamic spray (briefly “cold spray”).

Gas is conveyed in the dynamic spray device 5 through the spray torch 6 and then the spray gas supply duct 2. The gas is nitrogen or helium, for example. The gas is a very high-speed gas. A powdered material is conveyed in the dynamic spray device 5 via the powdered material supply duct 7. For example, the powdered material is aluminium powder.

The gas and powdered material mix in the mixing chamber 3 to form an accelerated mixture.

The accelerated mixture is then propelled at supersonic speed and ejected from the dynamic spray device 5 via the spray opening 41 towards the surface to be hardfaced. Once propelled out of the nozzle 1, solid particles forming the accelerated mixture collide with the surface to be hardfaced beyond a certain spray distance. Particles pile up and form a coating on the surface to be hardfaced.

The spray device 5 can then be moved to repeat the hardfacing method in order to hardface another surface of the annular contact flange.

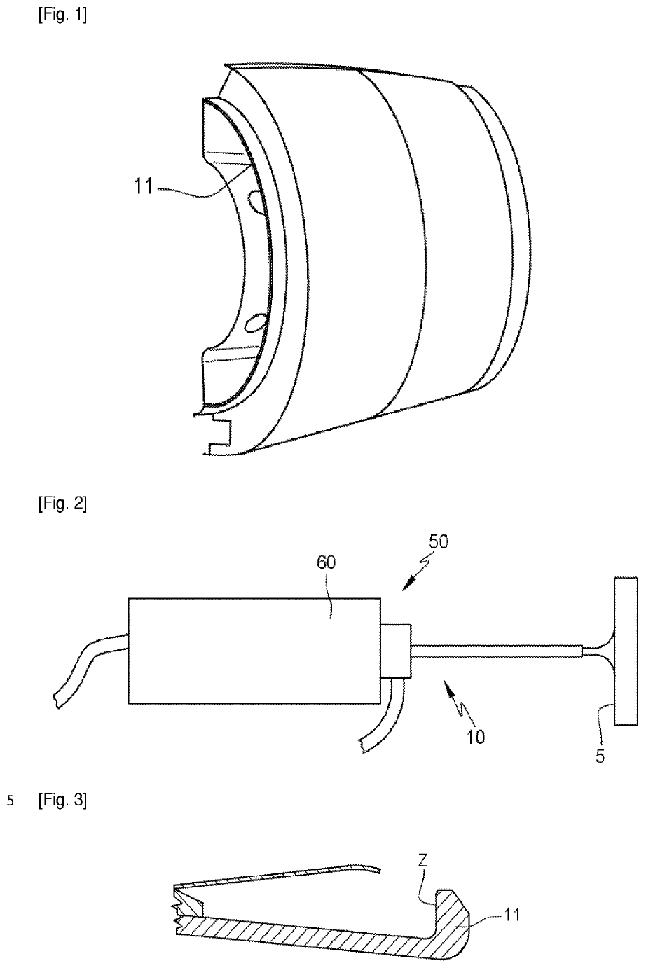

The repair method previously described for an annular contact flange can be adapted to any other component whose shape and arrangement in a turbomachine does not allow the use of a conventional spray device, such as that of FIG. 1.

1. A device for gas dynamically spraying powdered material comprising a nozzle comprising:
a spray gas supply duct,
a chamber for mixing spray gas and powdered material to form an accelerated mixture, connected, through an upstream end to the spray gas supply duct,
a spray duct for the accelerated mixture connected to a downstream end of the mixing chamber,
the spray gas supply duct is shaped with a first arm oriented along a first axis and a second arm oriented along a second axis perpendicular to the first axis, the first arm being connected to the upstream end,
the spray duct for the accelerated mixture rectilinearly extends along the first axis and comprises a spray opening, and:
a spray torch extending along the second axis and connected to the second arm of the spray gas supply duct,
a powdered material supply duct connected to the mixing chamber, characterised in that the powdered material supply duct extends along a third axis perpendicular to the first axis and to the second axis.

2. A method for coating a metal piece by dynamically spraying powder, implemented by a device for dynamically spraying powder according to claim 1, comprising:
positioning a surface to be coated facing the spray opening,
injecting high-speed gas into the spray torch,
injecting a powder into the powdered material supply duct, and
spraying the mixture formed by the high-speed gas and the powder via the spray duct onto the surface to be coated.

3. The coating method according to claim 2, wherein the high-speed gas is a cold gas.

4. The coating method according to claim 2, wherein the powder is mostly comprised of aluminium or aluminium alloy.

5. A method for repairing an annular contact flange for an aircraft turbomachine implemented by a dynamic spray device according to claim 1, comprising:
positioning a part of the annular contact flange to be repaired facing the spray opening,
injecting high-speed gas into the spray torch,
injecting a metallic powder into the powdered material supply duct,
spraying the mixture formed by the high-speed gas and the metallic powder via the spray duct onto said part,
wherein the annular contact flange is installed on a turbomachine.
